(19) United States
(12) Patent Application Publication
(10) Pub. No.: US 2024/0170194 A1
(43) Pub. Date: May 23, 2024

(54) MAGNETIC ELEMENT, MANUFACTURING METHOD AND POWER SUPPLY CIRCUIT THEREOF

(71) Applicant: Silergy Semiconductor Technology (Hangzhou) LTD, Hangzhou (CN)

(72) Inventors: Ke Dai, Hangzhou (CN); Jian Wei, Hangzhou (CN); Jiajia Yan, Hangzhou (CN)

(21) Appl. No.: 18/387,153

(22) Filed: Nov. 6, 2023

(30) Foreign Application Priority Data
Nov. 17, 2022 (CN) 202211472901.1
May 4, 2023 (CN) 202310500442.1

(51) Int. Cl. H01F 27/02; H01F 27/24; H01F 27/28; H01F 41/02

(52) U.S. Cl. CPC H01F 27/022; H01F 27/027; H01F 27/24; H01F 27/2804; H01F 41/02

(57) ABSTRACT

A magnetic element can include: at least one group of inner cores; where each group of inner cores comprises a lower magnetic core cover plate, a first winding, at least one middle magnetic core cover plate, a second winding, and an upper magnetic core cover plate that are stacked in sequence; where the first winding and the second winding are spaced by the at least one corresponding middle magnetic core cover plate; and where materials of the upper magnetic core cover plate, the middle magnetic core cover plate, and the lower magnetic core cover plate comprise a metal magnetic powder core material.

### RELATED APPLICATIONS

This application claims the benefit of Chinese Patent Application No. 202310500442.1, filed on May 4, 2023, which claims the benefit of Chinese Patent Application No. 202211472901.1, filed on Nov. 17, 2022, both of which are incorporated herein by reference in their entirety.

### FIELD OF THE INVENTION

The present invention generally relates to the field of inductors, and more particularly to magnetic elements and associated manufacturing methods and power supply circuitry.

### BACKGROUND

Coupling inductors are increasingly utilized in voltage regulator module (VRM) circuits. This is because negative coupling characteristics can reduce ripple and improve the dynamic characteristics of inductors under an interleave operation. Due to the cancellation of DC magnetic flux, the size of magnetic elements can accordingly be reduced.

### BRIEF DESCRIPTION OF THE DRAWINGS

FIG. 1 is a structural schematic diagram of an example magnetic element.

FIG. 2 is a schematic diagram of a first example magnetic element with stacked structure, in accordance with embodiments of the present invention.

FIG. 3 is a schematic diagram of a second example magnetic element with stacked structure, in accordance with embodiments of the present invention.

FIG. 4 is a schematic diagram of a third example magnetic element with stacked structure, in accordance with embodiments of the present invention.

FIG. 5 is a schematic diagram of a fourth example magnetic element with stacked structure, in accordance with embodiments of the present invention.

FIG. 6 is structure diagram of a first portion of an example process flow for the magnetic element, in accordance with embodiments of the present invention.

FIG. 7 is structure diagram of a second portion of an example of example process flow for the magnetic element, in accordance with embodiments of the present invention.

FIG. 8 is structure diagram of a third portion of an example of example process flow for the magnetic element, in accordance with embodiments of the present invention.

FIG. 9 is structure diagram of a fourth portion of an example of example process flow for the magnetic element, in accordance with embodiments of the present invention.

FIG. 10 is structural schematic diagram of two groups of two-phase magnetic elements, in accordance with embodiments of the present invention.

FIG. 11 is a schematic diagram of an example buck power supply circuit, in accordance with embodiments of the present invention.

FIG. 12 is a schematic diagram of an example boost power supply circuit, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

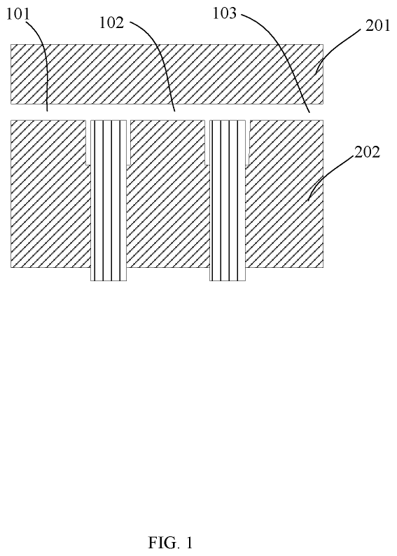

Referring now to FIG. 1, shown is a structural schematic diagram of an example magnetic element. This particular example shows the structure of a double-path coupling inductor, including ferrite 201 and ferrite 202. The upper surface and side surface of ferrite 202 are provided with grooves for the installation of winding, and the coupling degree of the inductor can be adjusted by adjusting the sizes of three air gaps 101, 102, and 103. The saturation magnetic flux density and power density of the ferrite of the double-path coupling inductor are relatively low, and the sizes of the three air gaps can be difficult to control, which may not be conducive to mass production and automatic production.

In particular embodiments, a magnetic element is provided, and can include an encapsulation layer and an inner core, where the encapsulation layer encapsulates the inner core, and the inner core includes a lower magnetic core cover plate, a first winding, at least one middle magnetic core cover plate, a second winding, and an upper magnetic core cover plate which are sequentially stacked. The first and second windings are respectively embedded in at least one adjacent magnetic core cover plate, and the upper magnetic core cover plate. The materials of the middle magnetic core cover plate and the lower magnetic core cover plate can include metal magnetic powder cores. The magnetic element can be a coupling inductor or a transformer.

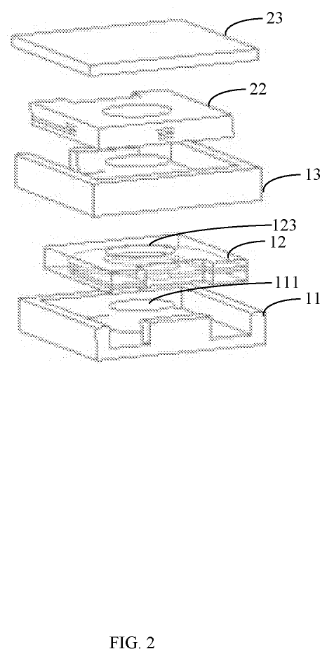

Referring now to FIG. 2, shown is a schematic diagram of a first example magnetic element with stacked structure, in accordance with embodiments of the present invention. In this particular example, the first and second windings can be located in winding substrates 12 and 22 respectively. Also, winding substrates 12 and 22 may respectively be embedded in one of the adjacent magnetic core cover plates. That is, the inner core may be formed by sequentially stacking lower magnetic core cover plate 11, winding substrate 12, middle magnetic core cover plate 13, winding substrate 22, and upper magnetic core cover plate 23.

The magnetic element can also include an encapsulation layer encapsulating all the inner cores. The side surface of the encapsulation layer can include openings for exposing the head and tail terminals of windings in each of the first winding substrates and each of the second winding substrates. The encapsulation layer can be made of a resin material. It should be noted that the encapsulation layer encapsulates the magnetic element integrally, such that the encapsulated magnetic element has increased reliability. The material of the encapsulation layer can also be an insulating material, such as epoxy resin.

Winding substrates 12 and 22 can be flat substrates, including an opening (e.g., opening 123) located in the middle of the flat substrate and winding wiring located inside or on the surface of the flat substrate, and with the winding wiring surrounding the opening. For example, the flat substrate can be a multi-layer board or a printed-circuit board (PCB). The wires of PCB boards of adjacent layers can connect through vias of PCB boards, and the wires of each layer may be routed around the middle opening. The wires of each layer have a starting point and an ending point, and the winding wires of two adjacent layers can connect through vias of PCB boards, and finally a winding substrate having multi-layer wiring layers may be formed. Also, the head and tail terminals of the winding may respectively be located at the top layer and the bottom layer of the multilayer board or the multilayer PCB board.

In other examples, winding substrates 12 and 22 can be configured as electroplated winding wires with substrates made of other materials as carriers, and the shape of the winding wires can be freely designed according to the shape of the flat substrate. As compared with a traditional winding of wound metal coil, the flat substrate of particular embodiments can make winding substrates 12 and 22 thinner, such that the whole magnetic element is thinner in height and smaller in volume. Also, the size of the magnetic element including two windings can be compatible with the size of the current standard inductor, and the thickness can be less than, e.g., 1 mm or 0.8 mm.

For example, the magnetic core cover plate embedded by winding substrate 12 or winding substrate 22 can be configured as an E-shaped cover plate. The E-shaped cover plate can include a magnetic core center column, whereby the cross section of the E-shaped cover plate presents the shape of letter E, and one side of the E-shaped cover plate can include two openings for exposing the head and tail terminals of the winding. As shown, when lower magnetic core cover plate 11 is an E-shaped cover plate, upper magnetic core cover plate 23 can be a flat cover plate, and middle magnetic core cover plate 13 an E-shaped cover plate.

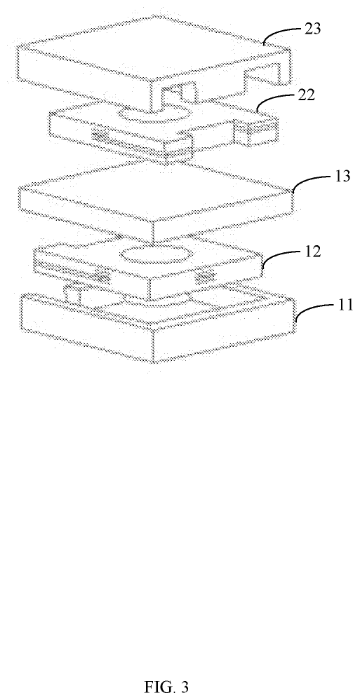

Referring now to FIG. 3, shown is a schematic diagram of a second example magnetic element with stacked structure, in accordance with embodiments of the present invention. In this particular example, when upper magnetic core cover plate 11 and lower magnetic core cover plate 23 are both E-shaped cover plates, middle magnetic core cover plate 13 can be a flat cover plate. The E-shaped cover plate can include a magnetic core center column, and the cross section of the E-shaped cover plate may present the shape of letter E. The magnetic core center column of the E-shaped cover plate can pass through an opening in the middle of the substrate where winding substrate 12 or winding substrate 22 is located.

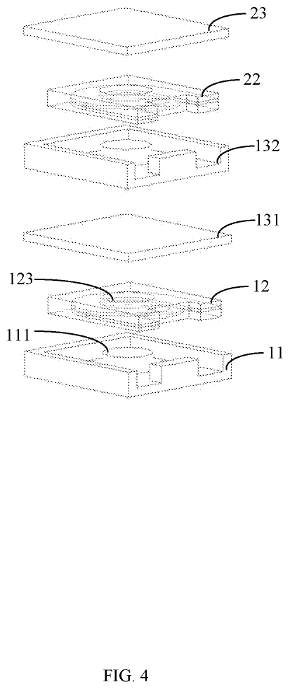

Referring now to FIG. 4, shown is a schematic diagram of a third example magnetic element with stacked structure, in accordance with embodiments of the present invention. In this particular example, middle magnetic core cover plate 13 can include two middle magnetic core cover plates 131 and 132. Winding substrate 12 can be located between lower magnetic core cover plate 11 and middle magnetic core cover plate 131, and winding substrate 22 may be located between middle magnetic core cover plate 132 and upper magnetic core cover plate 23. One of lower magnetic core cover plate 11 and middle magnetic core cover plate 131 can be a flat cover plate, and the other an E-shaped cover plate. One of upper magnetic core cover plate 23 and middle magnetic core cover plate 132 can be a flat cover plate, and the other is an E-shaped cover plate. The E-shaped cover plate can include a magnetic core center column, and the cross section of the E-shaped cover plate may present the shape of letter E. for example, lower magnetic core cover plate 11 and middle magnetic core cover plate 132 can be E-shaped cover plates, and middle magnetic core cover plate 131 and upper magnetic core cover plate 23 may be flat cover plates.

Magnetic core center column 111 of lower magnetic core cover plate 11 can pass through opening 123 in the middle of the substrate where winding substrate 12 is located. It should be noted that the shape of the substrate where the winding is located can be matched with the E-shaped cover plate, and the shape of the opening in the middle of the substrate can be matched with the shape of the magnetic core center column, such that the substrate may be placed inside the E-shaped cover plate. As an example (see, e.g., FIG. 2), the section of the magnetic core center column can be circular, and opening 123 in the middle of the substrate where the first winding substrate is located may also be circular. On the other hand, the cross section of the magnetic core center column can also be elliptical, square, polygonal, etc., as long as it matches the shape of the opening in the middle of the substrate. As shown in FIG. 1, the outer contour of the substrate may be rectangular, which matches the shape of the corresponding E-shaped cover plate. In other examples, the outer contour of the substrate can also be circular, elliptical, etc., as long as it matches the shape of the E-shaped cover plate, so there is no restriction here.

In FIGS. 2 to 4, the wiring of the first winding and the wiring of the second winding can be located in the first winding substrate and the second winding substrate, respectively. In other examples, the first and second windings of the magnetic element can also be metal wound coils, one of the magnetic core cover plates adjacent to the first and second windings can include a magnetic core center column, and both the first and second windings can surround the magnetic core center column in the adjacent magnetic core cover plate. One of the magnetic core cover plates adjacent to the first winding or the second winding may be provided with an opening for leading out the head and tail terminals of the first winding or the second winding.

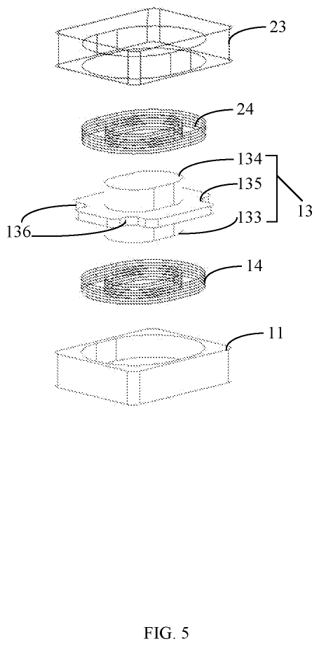

Referring now to FIG. 5, shown is a schematic diagram of a fourth example magnetic element with stacked structure, in accordance with embodiments of the present invention. In this particular example, windings 14 and 24 of the magnetic element can be metal wound coils. Middle magnetic core cover plate 13 can include middle magnetic core center columns 133 and 134, and flat cover plate 135 may be sandwiched between middle magnetic core center columns 133 and 134. Four corners of flat cover plate 135 may have openings 136 for them. Winding 14 can surround middle magnetic core center column 133, and winding 24 may surround middle magnetic core center column 134. Further, upper magnetic core cover plate 23 and lower magnetic core cover plate 11 can both be hollow, and the hollow shapes may respectively match the shapes of windings 14 and 24.

In other examples, middle magnetic core cover plate 13 may also include two middle magnetic core cover plates, where a first winding is located between a lower magnetic core cover plate and a first middle magnetic core cover plate, and a second winding is located between a second middle magnetic core cover plate and an upper magnetic core cover plate. In addition, middle magnetic core center columns 133 and 134 can also be respectively located in lower magnetic core cover plate 11 and upper magnetic core cover plate 23, or one of them can be located in middle magnetic core cover plate 13 and the other located in lower magnetic core cover plate 11 or upper magnetic core cover plate 23. The openings for leading out the head and tail terminals of the first winding or the second winding may all be located on middle magnetic core cover plate 13, lower magnetic core cover plate 11, or upper magnetic core cover plate 23. Alternatively, the openings of the head and tail terminals of one winding may be located on middle magnetic core cover plate 13, and the openings of the head and tail terminals of the other one can be located on lower magnetic core cover plate 11 or upper magnetic core cover plate 23, which is not limited here.

The materials of lower magnetic core cover plate 11, middle magnetic core cover plate 13, and upper magnetic core cover plate 23 may all be metal magnetic powder cores. It should be noted that materials of metal magnetic powder core is a kind of composite soft magnetic material with certain mechanical strength, which can be formed by mixing metal magnetic powder with insulating medium to form insulating coating powder, and then pressed into a specific shape through powder blending. Metal magnetic powders include but are not limited to carbonyl iron powder, Fe—Si—Al, Fe—Si, Fe—Si—Cr, Fe—Ni and other metal powders and amorphous and nanocrystalline alloy powders. Insulating coating agents can be roughly divided into organic coating agents (epoxy resin, polyamide resin, silicone resin, polyvinyl alcohol, phenolic resin and polystyrene, etc.) and inorganic coating agents (mica, water glass and oxide layer, etc.). This has advantages of high saturation magnetic induction intensity, high resistance, good frequency characteristics, low high-frequency loss, high-width constant magnetic permeability and constant magnetic permeability, and so on. Also, it has much higher saturation magnetic flux density and lower thermal conductivity than ferrite itself, which can be helpful in reducing the volume of the magnetic element. The magnetic element can also include pads, which may be located at the opening position on the surface of the encapsulation layer and electrically connected with the head and tail terminals of the windings in each of the first winding substrates and each of the second winding substrates.

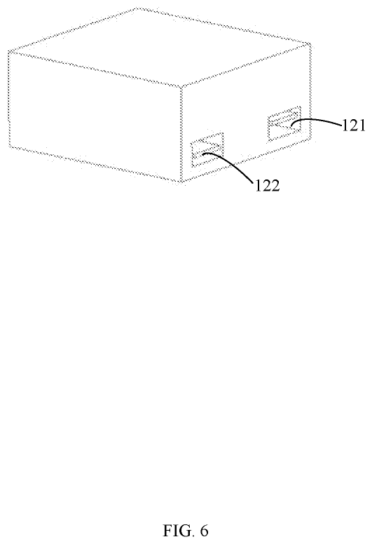

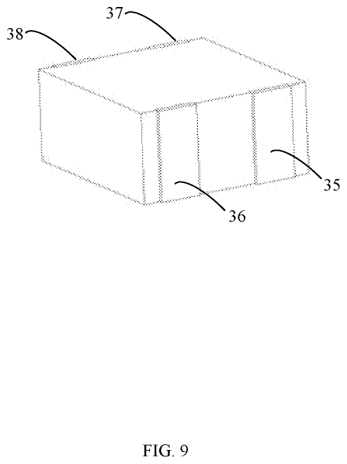

Referring now to FIGS. 6-9, shown are structure diagrams of an example process flow for the magnetic element, in accordance with embodiments of the present invention. The magnetic element in this example can include two windings, and each winding can include two pads corresponding to the head and tail terminals of the winding. As shown in FIG. 9, two opposite faces of the encapsulation layer may be provided with pads that are electrically connected with the first and second windings in first and second winding substrates 12 and 22, respectively, and the pads may extend from side surfaces of to the bottom surface of the magnetic element. The first winding substrate corresponds to two pads 35 and 36, and the second winding substrate corresponds to two pads 37 and 38, so the magnetic element of this example can include four pads for connecting magnetic element to the required circuit board by welding. Two pads connected with the same winding can be arranged on the same side surface (a first side surface) of the magnetic element and extend to the bottom surface of the magnetic element, and two pads connected with another winding may be arranged on the another side surface (opposite to the first side surface) and can extend to the bottom surface of the magnetic element. As a second example, two pads connected with the same winding may respectively be arranged on two opposite side surfaces of the magnetic element and can extend to the bottom surface of the magnetic element, and two pads connected with another winding may also respectively be arranged on the two opposite side surfaces and extend to the bottom surface of the magnetic element.

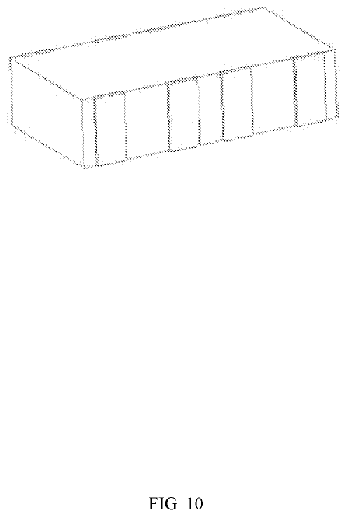

It should be noted that when the first winding and the second winding are metal wound coils (see, e.g., FIG. 5), the head and tail terminals of the first winding or the second winding can be led out through openings on one of the adjacent magnetic core cover plates. In this case, the head and tail terminals can be led out to the side surfaces of the magnetic element or directly to the bottom surface of the magnetic element. When the head and tail terminals are directly led out to the bottom surface of the magnetic element, the corresponding openings and pads of the encapsulation layer may also be arranged on the bottom surface of the magnetic element, so it may not be necessary to arrange the openings on the side surfaces and then extend the pads from the side surfaces to the bottom surface as shown in FIGS. 9 and 10.

Particular embodiments also provide a manufacturing method of the magnetic element, and the manufacturing and assembly process of the magnetic element is relatively simple, which is suitable for batch automatic production. With reference to FIGS. 6-9, the process flow diagrams of the magnetic element can include preparing a lower magnetic core cover plate, a middle magnetic core cover plate, an upper magnetic core cover plate, a first winding substrate, and a second winding substrate. For example, an integrated molding and pressing process can be used to prepare the lower magnetic core cover plate, the middle magnetic core cover plate, and the upper magnetic core cover plate using prepared metal magnetic powder cores. Next, the lower magnetic core cover plate, the first winding substrate, the middle magnetic core cover plate, the second winding substrate and the upper magnetic core cover plate can be stacked in this order, thereby forming a stacked device. Next, the stacked device may be integrally pressed to form a pressed device.

For example, when the wiring of the first winding and the wiring of the second winding are located in the first winding substrate and the second winding substrate respectively, the preparing of the first and second winding substrates can include arranging the winding wiring of the first and second windings in the inside or on the surface of the first and second winding substrates, and forming an opening in the middle of the first and second winding substrates, respectively. When the first and second windings are both metal wound coils, the metal coils may be used for winding to form the first and second windings.

Referring now to FIG. 6, shown is structure diagram of a first portion of an example process flow for the magnetic element, in accordance with embodiments of the present invention. For example, the stacked device can be integrally pressed by heat pressing process. After the stacked device is integrally pressed, when the wiring of the first winding and the wiring of the second winding are located in the first and second winding substrates, respectively, the ends of winding substrates 12 and 22 are grounded, such that the head and tail terminals of the first and second windings in winding substrates 12 and 22 are exposed, respectively. Only two terminals 121 and 122 of the first winding substrate are shown in FIG. 6, but the two head and tail terminals of the second winding substrate can be located on the opposite side of the surface where the two head and tail terminals of the first winding substrate are located. In other examples, when the first and second windings of the magnetic element are metal wound coils, after the stacked device is integrally pressed, the head and tail terminals of the first and second windings can be led out to the outside of the device through openings on one of the adjacent magnetic core cover plates. As shown, the four terminals of the first and second windings can be led out to two opposite surfaces of the device, or all four terminals can be led out to the bottom surface of the device.

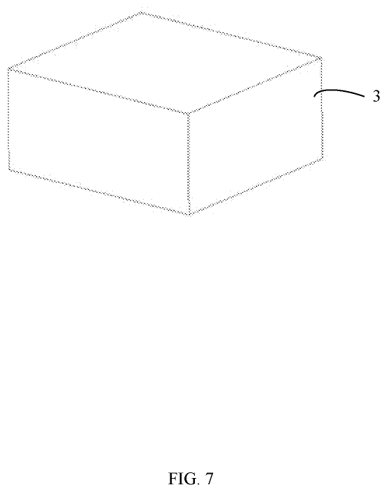

Referring now to FIG. 7, shown is structure diagram of a second portion of an example of example process flow for the magnetic element, in accordance with embodiments of the present invention. Here, the pressed device can be encapsulated as a whole as shown.

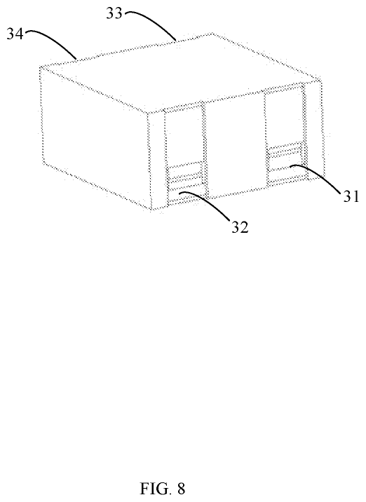

Referring now to FIG. 8, shown is structure diagram of a third portion of an example of example process flow for the magnetic element, in accordance with embodiments of the present invention. For example, the pressed device may be integrally encapsulated with resin. After the pressed device is encapsulated as a whole, the resin at the pins of winding substrates 12 and 22 may be removed to lead out a plurality of pads connected with the pins of winding substrates 12 and 22, respectively. When the pads are located on two opposite sides of the device, it may be necessary to extend the pads to the bottom surface of the device.

For example, laser peeling technology can be used to remove the resin at the head and tail terminals of the winding. The pads connected to the pins of winding substrates 12 and 22 can be led out by electroplating process. For example, the coupling coefficient between the first and second windings can be adjusted by adjusting the magnetic permeability of the middle magnetic core cover plate, the lower magnetic core cover plate, or the upper magnetic core cover plate. Cores with different magnetic permeability can be made by using the same metal magnetic powder core material but different manufacturing processes, and the magnetic permeability can be changed mainly by adjusting the molding pressure and heat treatment process. Also, the magnetic permeability can be adjusted by changing the size and shape of the powder particles of the magnetic powder core and changing the content of the insulating medium. In other examples, the magnetic permeability can also be adjusted by changing the material of the magnetic powder core.

When the magnetic permeability of the adjusted middle magnetic core cover plate 13 is lower than that of lower magnetic core cover plate 11 and upper magnetic core cover plate 23, the coupling degree of the first and second windings may determine the proportion of the mutual inductance magnetic flux path of the two windings to the total magnetic flux. Because the magnetic permeability of middle magnetic core cover plate 13 is relatively low, the magnetic resistance of the self-inductance magnetic flux path of the first or second winding can increase, the self-inductance magnetic flux may decrease, and the proportion of the magnetic flux of the mutual inductance magnetic flux path can significantly increase. Thus, the coupling coefficient of the first and second coils can be significantly increased as follows in formula (1).

Kcouple=Ψc/(Ψc+Ψs) (1)

Here, Ψc is the magnetic flux of the first winding or the second winding coupled to the other winding, and Ψs is the self-inductance magnetic flux of the first winding or the second winding. Because the magnetic permeability of the middle magnetic core cover plate between the first and second windings is relatively low, Ψs can become smaller, thus the coupling coefficient Kcouple may become larger.

Referring now to FIG. 10, shown is structural schematic diagram of two groups of two-phase magnetic elements, in accordance with embodiments of the present invention. The above-mentioned magnetic element structure and the corresponding manufacturing method may correspond to an inner core; that is, a group of two-phase magnetic elements. When the magnetic element includes N groups of inner cores, it can correspond to N groups of two-phase magnetic elements, and each inner core may be arranged in a row side by side. The N lower magnetic core cover plates corresponding to the N inner cores can be integrally formed into a first structural member, and the N middle magnetic core cover plates corresponding to the N inner cores may be integrally formed into a second structural member. N upper magnetic core cover plates corresponding to the N inner cores may be integrally formed into a third structural member. N first winding substrates 12 placed side by side can be located between the first structural member and the second structural member, and N second winding substrates 22 placed side by side may be located between the second structural member and the third structural member. That is, the inner cores of N magnetic elements can be placed side by side. For example, N is a positive integer and N>2. Also, the encapsulation layer can be an encapsulation layer that encapsulates all the inner cores.

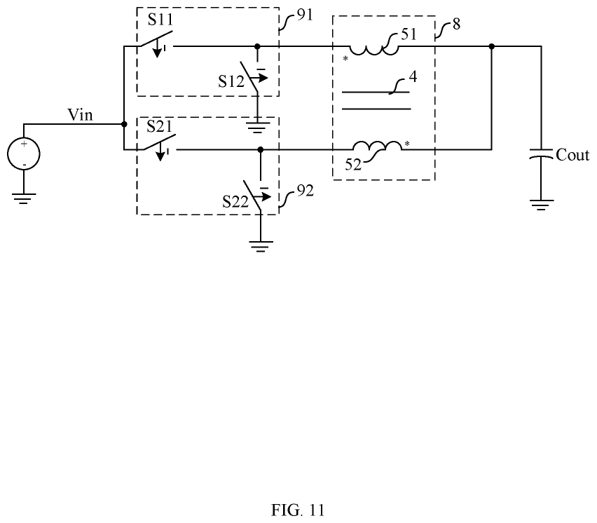

Referring now to FIG. 11, shown is a schematic diagram of an example buck power supply circuit, in accordance with embodiments of the present invention. In this particular example, the coupling inductor is a magnetic element and a group of two-phase coupling inductors can be obtained by the manufacturing method described above. Due to the high coupling coefficient of the coupling inductor adopting the above structure and method, the conversion efficiency of the power supply circuit can be greatly improved and the power loss reduced.

For example, the power supply circuit can include coupling inductor 8, switching module 91, switching module 92, and capacitor Cout. In this example, switch module 91 can include switches S11 and S1. A first terminal of switch S11 in switch module 91 may receive input voltage Vin, a second terminal of switch S11 can connect to a first terminal of winding 51 in inductor 8, a second terminal of winding 51 can connect to an upper plate of capacitor Cout, and a lower plate of capacitor Cout may be grounded. A first terminal of switch S12 in switch module 91 can connect to the connection node of switch S11 and winding 51, and a second terminal of switch S12 in switch module 91 may be grounded. In switch module 91, when switch S11 is in the turn-on state, switch S12 can be in the turn-off state, and correspondingly, when switch S11 is in the turn-off state, switch S12 may be in the turn-on state.

Switch module 92 can include switches S21 and S22. A first terminal of switch S21 in switch module 92 may receive input voltage Vin, and a second terminal of switch S21 in switch module 92 can connect to a first terminal of winding 52 in inductor 8. A second terminal of winding 52 can connect to an upper plate of output capacitor Cout, and a lower plate of capacitor Cout may be grounded. A first terminal of switch S22 in switch module 92 can connect to the connection node of switch S21 and winding 52, and a second terminal of switch S22 in switch module 92 may be grounded. In switch module 92, when switch S21 is in the turn-on state, switch S22 can be in the turn-off state, and correspondingly, when switch S21 is in the turn-off state, switch S22 may be in the turn-on state.

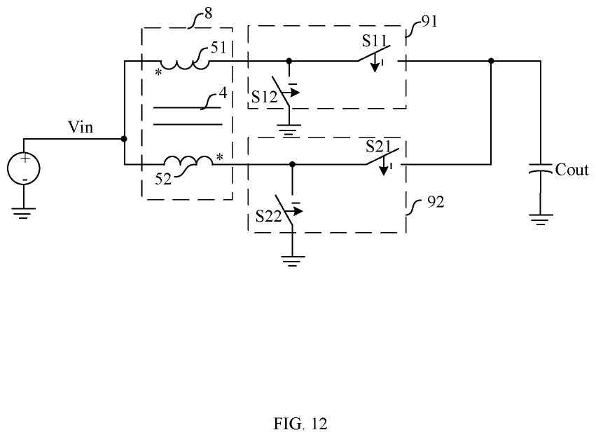

Referring now to FIG. 12, shown is a schematic diagram of an example boost power supply circuit, in accordance with embodiments of the present invention. In this particular example, the boost power supply circuit can include coupling inductor 8, switching module 91, switching module 92, and capacitor Cout. The coupling inductor can be a magnetic element obtained by adopting the structure and manufacturing method described above. Due to the high coupling coefficient of the coupling inductor adopting the above structure and method, the conversion efficiency of the power supply circuit may be greatly improved and the power loss reduced.

In this example, switch module 91 can include switches S11 and S12. A first terminal of winding 51 in inductor 8 may receive input voltage Vin, a second terminal of winding 51 can connect with a first terminal of switch S12 in switch module 91, and a second terminal of switch S12 in switch module 91 may be grounded. A first terminal of switch S11 in switch module 91 can connect to the connection node between switch S11 and winding 51, a second terminal of switch S11 in switch module 91 can connect to an upper plate of capacitor Cout, and a lower plate of capacitor Cout may be grounded. In switch module 91, when switch S11 is in the turn-on state, switch S12 can be in the turn-off state, and correspondingly, when switch S11 is in the turn-off state, switch S12 may be in the turn-on state.

Switch module 92 can include switches S21 and S22. A first terminal of winding 52 in inductor 8 may receive input voltage Vin, a second terminal of winding 52 can connect with one terminal of switch S22 in switch module 92, and a second terminal of switch S22 in switch module 92 may be grounded. A first terminal of switch S21 in switch module 92 can connect to the connection node of switch S22 and winding 52, a second terminal of switch S21 in switch module 92 can connect to an upper plate of capacitor Cout, and a lower plate of capacitor Cout may be grounded. In switch module 92, when switch S21 is in the turn-on state, switch S22 can be in the turn-off state, and correspondingly, when switch S21 is in the turn-off state, switch S22 may be in the turn-on state.

It should be noted that when the power supply circuit includes 2*N switch modules connected in parallel with each other, and the composition of each switch module is the same as that in the boost or buck circuit diagram in FIGS. 11 and 12, the switch modules may operate under phase-shift control. In this example, the coupling inductors can be N groups of two-phase magnetic elements obtained by the structure and manufacturing method described above, and the two-phase coupling inductors in the same group may be out of phase by 180 degrees. In addition, it should be noted that the transformer in the power stage circuit can also be configured as the above-mentioned magnetic element.

Particular embodiments provide a magnetic element, a manufacturing method, and a power supply circuit thereof. The magnetic element can include an encapsulation layer and an inner core, where the encapsulation layer encapsulates the inner core, and the inner core is formed by sequentially overlapping a lower magnetic core cover plate, a first winding substrate, a middle magnetic core cover plate, a second winding substrate, and an upper magnetic core cover plate. Also, two opposite surfaces of the encapsulation layer may be provided with pads respectively connected with the first and second winding substrates. The corresponding manufacturing method can include preparing a lower magnetic core cover plate, a middle magnetic core cover plate, an upper magnetic core cover plate, a first winding substrate, and a second winding substrate. The lower magnetic core cover plate, the first winding substrate, the middle magnetic core cover plate, the second winding substrate, and the upper magnetic core cover plate can be stacked in sequence. The stacked device can be pressed as a whole. Also, the pressed device can be packaged as a whole. In particular embodiments, the shape of the winding coil can be freely designed, and the process of the winding substrate can make the winding thinner, which can be helpful in reducing height of the inductor. Also, the magnetic core cover plate can be made of metal magnetic powder core material, which has high saturation magnetic flux density and can be helpful to realize a smaller inductor volume. The production and assembly process of the magnetic element is relatively simple, and is suitable for batch automatic production. Also, due to the existence of the packaging pad of the magnetic element, the magnetic element can adopt more convenient automatic mass production processes, such as patch.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A magnetic element, comprising:
a) at least one group of inner cores;
b) wherein each group of inner cores comprises a lower magnetic core cover plate, a first winding, at least one middle magnetic core cover plate, a second winding, and an upper magnetic core cover plate that are stacked in sequence;
c) wherein the first winding and the second winding are spaced by the at least one corresponding middle magnetic core cover plate; and
d) wherein materials of the upper magnetic core cover plate, the middle magnetic core cover plate, and the lower magnetic core cover plate comprise a metal magnetic powder core material.

2. The magnetic element of claim 1, wherein the first winding and the second winding are respectively embedded in correspondingly one of the lower, middle, and upper magnetic core cover plates.

3. The magnetic element of claim 1, further comprising an encapsulation layer encapsulating all the inner cores, wherein at least one surface of the encapsulation layer comprises a plurality of openings for exposing head and tail terminals of each of the first windings and the second windings.

4. The magnetic element of claim 3, further comprising a plurality of pads, wherein each of the plurality of pads are respectively located at the openings and are respectively electrically connected with the head and tail terminals of the first winding and the second winding.

5. The magnetic element of claim 3, wherein the encapsulation layer comprises a resin material.

6. The magnetic element of claim 1, wherein the first winding and the second winding are respectively located in the first winding substrate and the second winding substrate, and the first winding substrate and the second winding substrate are respectively embedded in one of the adjacent magnetic core cover plates.

7. The magnetic element of claim 6, wherein:
a) the magnetic core cover plate embedded by the first winding substrate or the second winding substrate is configured as an E-shaped cover plate, and other adjacent magnetic core cover plate is configured as a flat cover plate;
b) the E-shaped cover plate comprises a magnetic core center column, a cross section of the E-shaped cover plate presents a shape of letter E, and one side surface of the E-shaped cover plate comprises two openings for exposing the head and tail terminals of the first winding or the second winding.

8. The magnetic element of claim 6, wherein the first winding substrate and the second winding substrate are configured as flat substrates, each flat substrate comprises an opening located in the middle of the flat substrate, and winding wiring located inside or on the surface of the flat substrate and surrounding the opening.

9. The magnetic element of claim 6, wherein when each group of inner cores comprises a first middle magnetic core cover plate and a second middle magnetic core cover plate, the first winding substrate is located between the lower magnetic core cover plate and the first middle magnetic core cover plate, and the second winding substrate is located between the second middle magnetic core cover plate and the upper magnetic core cover plate.

10. The magnetic element of claim 9, wherein:
a) one of the lower magnetic core cover plate and the first middle magnetic core cover plate is a flat cover plate, and the other is an E-shaped cover plate;
b) one of the upper magnetic core cover plate and the second middle magnetic core cover plate is a flat cover plate, and the other is an E-shaped cover plate; and
c) the E-shaped cover plate comprises a magnetic core center column, and a cross section of the E-shaped cover plate presents a shape of letter E.

11. The magnetic element of claim 7, wherein the magnetic core center column of the E-shaped cover plate passes through the opening of a flat substrate where the first winding substrate or the second winding substrate is located.

12. The magnetic element of claim 1, wherein the first winding and the second winding are metal wound coils.

13. The magnetic element of claim 12, wherein:
a) one of the magnetic core cover plates adjacent to the first winding and one of the magnetic core cover plates adjacent to the second winding each comprises a magnetic core center column;
b) wound coils of the first winding and the second winding both surround the magnetic core center columns;
c) a remaining magnetic core cover plate is a flat substrate with a hollow shape, and a hollow shape is respectively matched with the middle column of the magnetic core wound with the first winding and the second winding.

14. The magnetic element of claim 13, wherein the magnetic core cover plate wound with the first winding or the second winding is provided with an opening for leading out head and tail terminals of the first winding or the second winding.

15. The magnetic element of claim 14, wherein:
a) each group of inner cores comprises a first middle magnetic core cover plate and a second middle magnetic core cover plate;
b) the first winding is located between the lower magnetic core cover plate and the first middle magnetic core cover plate; and
c) the second winding is located between the second middle magnetic core cover plate and the upper magnetic core cover plate.

16. The magnetic element of claim 1, wherein:
a) the magnetic element comprises N groups of inner cores, the inner cores being arranged side by side, wherein N is a positive integer greater than 2;
b) the N lower magnetic core cover plates corresponding to the N inner cores are integrally formed into a first structural member, and the N middle magnetic core cover plates corresponding to the N inner cores are integrally formed into a second structural member; and
c) N upper magnetic core cover plates corresponding to the N inner cores are integrally formed into a third structural member.

17. The magnetic element of claim 1, wherein the magnetic element is a coupling inductor or a transformer.

18. A method of manufacturing the magnetic element of claim 1, the method comprising:
a) preparing an upper magnetic core cover plate, an middle magnetic core cover plate, and an lower magnetic core cover plate are located, and preparing the first winding and the second winding;
b) stacking the lower magnetic core cover plate, the first winding, the middle magnetic core cover plate, the second winding, and the upper magnetic core cover plate in sequence to form a stacked device;
c) integrally pressing the stacked device; and
d) packaging the pressed device as a whole.

19. The method of claim 18, further comprising:
a) arranging winding wiring of the first winding and the second winding in or on surfaces of a first winding substrate and a second winding substrate; and
b) forming an opening in the middle of the first winding substrate and an opening in the middle of the second winding substrate.

20. The method of claim 19, wherein after the stacked device is integrally pressed, grounding ends of the first winding substrate and the second winding substrate, such that head and tail terminals of the first winding and the second winding in the first winding substrate and the second winding substrate are exposed.
